(19) United States
(12) Patent Application Publication
(10) Pub. No.: US 2015/0103975 A1
(43) Pub. Date: Apr. 16, 2015

(54) X-RAY IMAGE SENSOR AND X-RAY IMAGE SENSOR SYSTEM USING THE SAME

(71) Applicant: NATIONAL CHIAO TUNG UNIVERSITY, Hsinchu City (TW)

(72) Inventor: KEI-HSIUNG YANG, TAOYUAN COUNTY (TW)

(73) Assignee: NATIONAL CHIAO TUNG UNIVERSITY, Hsinchu City (TW)

(21) Appl. No.: 14/051,656

(22) Filed: Oct. 11, 2013

(51) Int. Cl. G01T 1/24; G01N 23/04

(52) U.S. Cl. CPC G01T 1/24; G01N 23/04
USPC 378/62; 250/370.09

(57) ABSTRACT

An x-ray image sensor and an x-ray image sensor system using the same is disclosed. The x-ray image sensor has a back-light unit emitting actinic and non-actinic lights. There is an x-ray-photoconductor-assisted liquid crystal light valve including an x-ray photoconductive unit to absorb x-rays passing through an object to be imaged and create a charge image corresponding to an image of the x-rays and a liquid crystal cell unit to convert the charge image into at least one optical image illuminated by the non-actinic light. The optical image is detected by an optical imager. The optical imager is coupled to a processor converting data of the optical image into picture archiving and communication system (PACS)-compatible format for further storages, distributions, and displays.

### BACKGROUND OF THE INVENTION

1. Field of the Invention

The present invention relates to an image sensor, particularly to an x-ray image sensor and an x-ray image sensor system using the same.

2. Description of the Related Art

Phosphor screens have been used to absorb most of x-rays passing through a patient or an object to be imaged. The phosphor screen converts the absorbed x-rays into visible light to expose a photographic film, later developed in a dark room to become a visible image on the film for viewing.

However, over recent years, a trend towards digital x-ray imaging instead of screen-film imaging has been developed. One known prior art of digital x-ray imaging system is based on screen-film image digitization. However, film-image digitization suffers from the same inconveniences as film handling and development and requires additional steps resulting in high cost and time consuming. Furthermore, the quality of images generated by this digitization method is only as good as the image from the original film.

Another trend of digital radiographic imaging has used a lens or lens system to couple optically an x-ray-absorbing phosphor screen to a CCD (charge-coupled device) optical imager whose output is fed to a processor connected to a display for image viewing. Unfortunately, the quality of images generated is unsatisfactory because only a fraction of visible or infrared photons released by the phosphor screen are collected by the lens or the lens system to the CCD optical imager. Increasing x-ray exposure to improve the image quality is not an accepted solution due to increasing risk to the patients. To overcome the coupling inefficiency associated with the above system, an x-ray image sensor was invented and described in U.S. Pat. No. 5,847,499 that disclosed an x-ray image sensor comprised a twisted nematic (TN) liquid crystal (LC) cell constructed on an amorphous selenium (a-Se) film. A CCD camera captured the optical image from the LC cell and fed the captured data to a processor where the optical-image data were digitized and displayed. In operation, a potential was applied across the x-ray photoconductive image sensor to create an electric field across the a-Se film. When x-rays passed through a patient and were absorbed in the a-Se film, field-assisted creation of electron-hole pairs occurred within the a-Se film. The electric field in the a-Se film separated the electrons and the holes and drove the electrons and holes to opposite surfaces of the a-Se film with the electrons being driven towards the LC cell unit. The negative charges collected at the interface between the a-Se film and the LC alignment layer created potential (or charge) variations across the LC cell to re-orientate the directors of LC molecules within the LC cell which affected the polarization state of light from an external source passing through the LC cell. A read-out optical beam passing through polarizers on opposed sides of the x-ray image sensor translated the changes in light-polarization direction to changes in light transmission. The net result was that variations in the electron-hole creations in areas of the a-Se film where x-rays were absorbed caused spatial variations in the intensity of light transmitted through the LC cell, thus producing an optical image of the x-ray exposure. The CCD optical imager captured the optical image allowing the processor to digitize and display the optical image. Although this x-ray image sensor exhibited high resolution, but noise was high due to its inability to reduced dark current through the x-ray photoconductive a-Se layer and its inability to compensate ionic current in the LC cell during image-forming operation. The uncompensated ionic current flowing within the LC cell during image formation behaves as dark current for the x-ray image sensor resulting in the optical image formed in the LC cell changing as a function of time. The sum of the dark current and the ionic current represented the dominant noise described in the prior art of U.S. Pat. No. 5,847,499.

To overcome the abovementioned problems, the present invention provides an x-ray image sensor and an x-ray image sensor system using the same, so as to solve the afore-mentioned problems of the prior art.

### SUMMARY OF THE INVENTION

A primary objective of the present invention is to provide an x-ray image sensor, which provides two additional layers of films to sandwich the a-Se layer of the prior art to reduce dark leakage current through the a-Se layer, and which implement a new operation voltage waveform applied to the x-ray image sensor to compensate ionic current in the LC cell for noise reduction and to stabilize the optical image formed in the LC cell during image-forming operation. The noise of x-ray image sensor of the present invention is drastically reduced compared with that of the traditional technology.

To achieve the abovementioned objectives, the present invention provides an x-ray-photoconductor-assisted liquid crystal light valve to be used as an x-ray image sensor comprising three major units: a flat-panel back-light (FPBL) unit to emit actinic and non-actinic lights, an x-ray photoconductive unit to absorb the x-ray photons passing through the object to be imaged and create a charge image corresponding to the x-ray image, and a liquid crystal (LC) cell unit to convert the charge image into a birefringence image. The present invention defines the non-actinic light and the actinic light where the x-ray photoconductive unit has a negligible attenuation and a strong absorption, respectively. Non-actinic light from the FPBL unit is set to incident upon a pair of polarizers sandwiching a stack of the x-ray photoconductive unit and the LC cell unit to convert the birefringence image in the LC cell unit into an optical image. The FPBL unit includes a thin opaque light-reflecting plate, a thin light-guiding (LGP) plate, and LED light sources which emit actinic light that the a-Se film x-ray photoconductive unit can strongly absorb to create electron-hole pairs within it and non-actinic light that the a-Se film in the x-ray photoconductive unit has a negligible absorption. The x-ray photoconductive unit comprises, in sequence, a thin transparent substrate, a transparent conductive electrode, a hole-injection blocking layer, an x-ray photoconductive layer preferably an amorphous selenium (a-Se) layer, and a pin-hole-free dielectric layer. The LC cell unit comprises a sealed LC medium in a cavity between two LC alignment layers with one layer fabricated on a transparent-conductive-electrode-coated transparent substrate and the other layer fabricated on the pin-hole-free dielectric layer of the x-ray photoconductive unit with the x-ray photoconductive layer absorbing x-rays passing through an object to be imaged to form an x-ray exposure of the object and generating an optical image in the LC cell unit between two polarizers, and one of the polarizers followed the FPBL unit to provide non-actinic-light illumination with proper polarization for the LC cell unit. It is preferred that the optical images exhibited by the LC cell unit are imaged to and detected by a CCD or a CMOS (complementary metal-oxide-semiconductor) connected to an image processor to convert the image data from the CCD camera into PACS (picture archiving and communication system)-compatible format for further storages, distributions, and displays.

It is also preferred that a programmable high voltage supply unit is provided to generate invented voltage waveforms applied to the transparent conductive electrodes on the x-ray photoconductive unit and the LC cell unit, respectively. If desired, a timing and triggering unit can be included to provide trigger signals to the programmable high voltage power supply unit to generate the invented voltage waveforms to turn on and off the x-ray source for x-ray exposure, to turn on and off the FPBL unit to emit actinic light absorbed in the photoconductive a-Se layer to create electron-hole pairs, and non-actinic readout light for the readout of the optical image resulted from the incident x-ray image, and to turn on and off the CCD camera for start and end of data acquisition. Also, in the invention, means of new structure and new invention of operation voltage waveforms are provided to reduce the noise by eliminating or reducing dark current through the a-Se layer and ionic current flowing within the LC cell unit. The reduction of noise implies the reduction of x-ray exposure to offer a great value to patients when taking medical x-ray examinations.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram showing an image sensor system according to an embodiment of the present invention;

FIG. 2 is a cross-sectional view showing a flat-panel back-light unit according to an embodiment of the present invention;

FIG. 3 is a cross-sectional view in side elevation showing an x-ray photoconductive unit and a liquid crystal cell unit according to an embodiment of the present invention; and

FIG. 4 is a diagram showing voltage waveforms versus time applied across two transparent conductive electrodes according to an embodiment of the present invention.

### DETAILED DESCRIPTION OF THE INVENTION

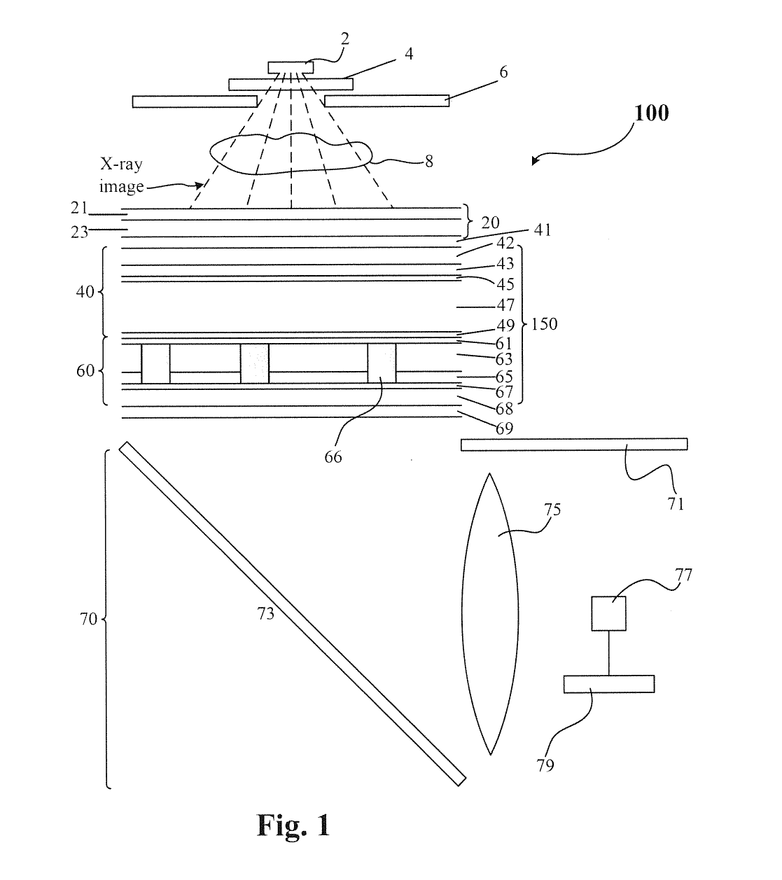

Referring now to FIG. 1 that shows an x-ray image sensor system including an x-ray image sensor 100 comprising a flat-panel back-light unit 20 emitting either actinic or non-actinic light or both to shine upon an x-ray-photoconductor-assisted liquid crystal light valve (p-LCLV) 150 shown in FIG. 1 and FIG. 3, which includes a pair of polarizers placed on the opposite sides of the combination of an x-ray photoconductive unit 40 with a built-in x-ray photoconductive amorphous selenium (a-Se) layer 47 to absorb the impinging x-ray image and create a charge image corresponding to the X-ray image and a liquid crystal (LC) cell unit 60 for converting the charge image into an optical image propagating to an optical system 70. The optical system 70 is disposed between the x-ray-photoconductor-assisted liquid crystal light valve 150 and an optical imager 77. The optical system 70 includes a reflective mirror 73 to reflect the optical image to be imaged by a lens or lens system 75 onto the optical imager 77 such as a CCD or CMOS optical imager to detect the optical image converted into an digital image by a processor 79 coupled to the optical imager 77. The optical imager 77 is in form of at least one imaging device in a linear array or at least 4 imaging devices in a 2-by-2 array, wherein the imaging device is a CCD camera or a CMOS image sensor. The x-ray image sensor system in FIG. 1 allows digitized optical images corresponding to x-ray exposure of objects such as patients to be captured. As can be seen in FIG. 1, the x-ray image sensor system includes an x-ray source 2 providing an x-ray beam to pass through a filter 4 and an aperture on an x-ray-shielding lead plate 6 to impinge upon a patient 8 to be imaged by an x-ray image sensor 100 and an optical system 70 comprising a reflective mirror 73 in the path of the x-ray image to reflect the optical image from the x-ray image sensor 100 toward the optical imager 77 placed behind an x-ray shielding lead plate 71 to prevent the optical imager 77 from damage by the x-ray beam from the x-ray source 2. After passing the patient 8, the x-ray image impinges upon the x-ray image sensor 100 that converts the input x-ray image into an optical image captured by the optical system 70 including a CCD or CMOS optical imager coupled to an image processor 79 storing the captured optical image and converting it into a digital image whose data are expressed in picture archiving and communication system (PACS)-compatible format for further storages, distributions, and displays. The image processor 79 is coupled to an electronic timer (not shown) providing trigger signals to the processor 79. When the optical imager 77 has received sufficient light to capture the optical image, the processor 79 digitizes and stores the optical image in response to the trigger signals.

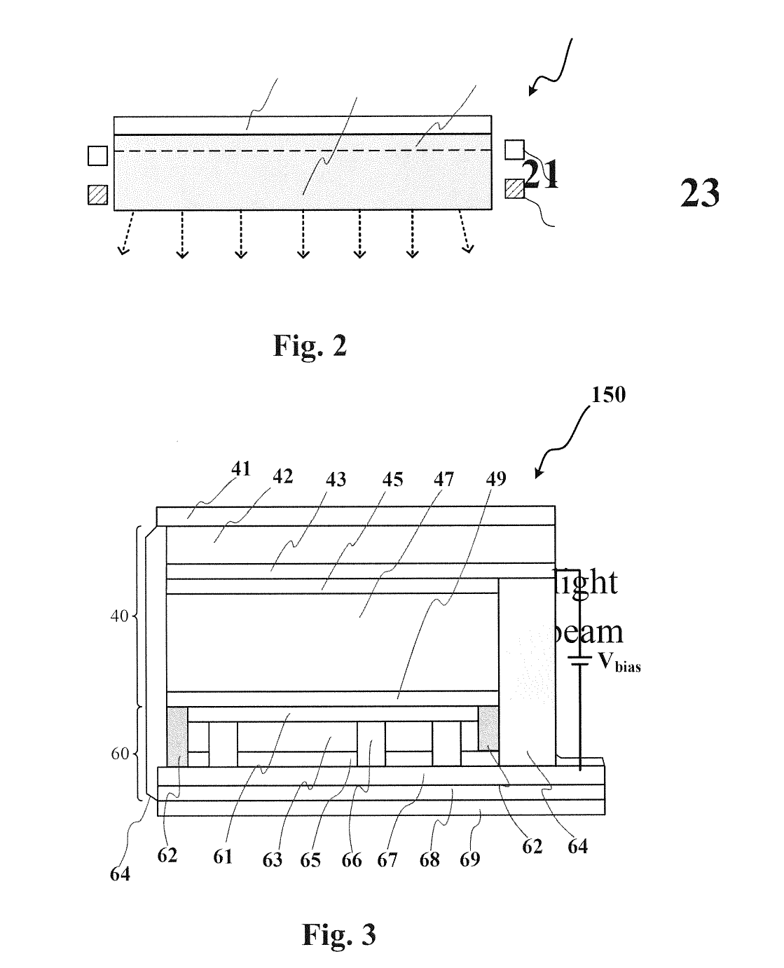

Turning now to FIG. 2, the flat-panel back-light (FPBL) unit 20 shown in FIG. 1 is depicted in more details. As shown in FIG. 2, the FPBL unit 20 comprising a thin reflecting back plate 21, a thin light-guiding plate (LGP) 23 adjacent thin reflecting back plate 21, an edge-lit LED light source 27 upon activated to emit non-actinic light in a wavelength from 750 to 1100 nm, and another edge-lit LED light source 28 upon activated to emit actinic light in a wavelength range from 400 to 680 nm. The LED light sources 27 and 28 and their driving circuitries are shielded by lead plates (not shown) against x-ray exposure from the x-ray source 2 shown in FIG. 1. Within the LGP 23 or on its surface adjacent the reflecting plate 21, there exist light diffractive elements 25 to diffract the light from LED light sources 27 and 28 towards the emitting surface of the LGP plate forming a substantially uniform light beam incident upon the p-LCLV 150 shown in FIG. 3. It is preferable to have the FPBL unit 20 made of light-element materials with a negligible attenuation for the incident x-rays. As shown in FIG. 3, placed between a polarizer 41 and a polarizer 69, the p-LCLV 150 comprises the x-ray photoconductive unit 40 to receive the incident x-ray image and convert it into an electrical charge image that operates on a LC cell unit 60 to generate an optical image to be captured by the optical system 70. The x-ray photoconductive unit 40 comprises a thin transparent substrate 42 made of either glass or polymeric material coated with following layers in sequence: a first transparent conductive electrode or indium-tin-oxide (ITO) layer 43, a hole-injection blocking layer 45 at a thickness from 50 to 300 nanometers, an x-ray photoconductive a-Se layer 47 at a thickness from 50 to 1000 micrometers preferably at 200 to 300 micrometers, a pin-hole-free dielectric layer 49 at a thickness from 50 to 1000 nanometers preferably at 100 to 300 nm. Both the hole-injection blocking layer 45 and the a-Se layer 47 are formed by thermal evaporation. The pin-hole-free dielectric layer 49 is preferably made of transparent poly-para-xylylenes fabricated by gas-phase chemical deposition at room temperature to avoid the crystallization of the underneath a-Se layer 47 because the re-crystallization of a-Se film drastically increases its dark current.

Fabricated on the x-ray photoconductive unit 40 is the LC cell unit 60 comprising a LC cavity formed by an upper x-ray photoconductive unit 40 and a lower substrate composed of a LC alignment layer 65 on a second transparent conductive ITO electrode 67 coated upon a transparent substrate 68. The cavity is enclosed by a glue seal 62 and contains post spacers 66 with a cross-sectional area from 5×5 to 15×15 micrometer and a thickness from 3 to 15 micrometers preferably 5 to 10 micrometers, and a liquid crystal medium as a LC mixture 63 preferably nematic LC mixtures of high resistivity larger than 10¹² ohm-cm aligned by two alignment layers 61 and 65 into a twisted nematic (TN) LC mode with positive dielectric anisotropy or tilted vertically-aligned (VA) LC mode with negative dielectric anisotropy or vertically-aligned reversed TN LC mode with negative dielectric anisotropy. The present invention define PI-LC-PI to include the alignment layers 61 and 65, and the LC mixture 63. The alignment layers 61 and 65 can be made of the same material. Prior to the assembly of the p-LCLV 150 shown in FIG. 3, firstly, the LC alignment layer 61 with a thickness from 0 to 200 nm preferably 100 nm is fabricated on the dielectric layer 49 preferably by oblique evaporation of SiOx and keeping the underneath a-Se film 47 below 65° C. during evaporation or by off-set printing of a polyimide (PI) film and cured by infrared or LED lamps providing non-actinic light not absorbed by the underneath a-Se layer 47 to keep its temperature below 65° C. during curing. After curing, the PI film 61 is, then, subjected to a rubbing on its face-up surface by a cylindrical roller wrapped with a cotton or velvet cloth for the alignment of LC molecules. The rubbing process can also be replaced by photo-induced LC alignment process on photosensitive PI films. Secondly, polymeric post spacers 66 are fabricated on the transparent conductive ITO electrode 67 coated on top of the transparent glass substrate 68 followed by the coating of the LC alignment layer 65. The process temperatures for the fabrications of the post spacers 66 and the LC alignment layer 65 by oblique evaporation of SiOx or off-set printing of PI film can be high up to 240° C. After the PI film 65 undergoes a hard-bake curing, its face-up surface is rubbed by the cylindrical roller as previously described for the alignment of LC molecules. The rubbing process can also be replaced by photo-induced LC alignment process on photosensitive PI films. The present invention prefers to use post-spacers 66 that can maintain a much better LC-cell gap uniformity than the conventional ball spacers. The LC alignment layer 65 is at a thickness from 50 to 200 nanometers preferably at 100 nm. The assembly of the LC cell unit 60 and the x-ray photoconductive unit 40 and the injection of LC mixture 63 into the LC cavity are, then, carried out by standard One-Drop-Fill (ODF) process being currently used in the assembly of thin-film-transistor-driven-liquid-crystal-displays (TFT-LCDs) by global TFT-LCD industries. The assembly can also be carried out by a traditional method with vacuum-injection of LC mixture 63 into the LC cavity and a glue seal is used to cover up the LC injection opening. After the assembly of the p-LCLV 150 and, in operation, a voltage, Vbias, is applied across the ITO layers 43 and 67 for the operation of the p-LCLV 150. Vbias will generate Vbias-se and Vbias-lc where the former is across the a-Se layer 47 to enable the generations and separations of the electron-hole pairs inside the Se layer from the absorbed x-rays. On the other hand, the Vbias-lc is across the PI-LC-PI to deform the directors of LC molecules within the LC mixture 63 for image formation. Furthermore, the exposed portions of ITO films 43 and 67 are protected by epoxy material 64 to inhibit a voltage breakdown when Vbias is at a high voltage. Epoxy 64 also seals the p-LCLV 150 to inhibit separation of the layers forming the p-LCLV 150.

Referring to FIG. 3, let us assume that the absorbed-x-rays generate electron-hole pairs in the a-Se layer 47 and only the holes are collected at the interface between the a-Se layer 47 and the dielectric layer 49 to deform the directors of LC molecules in the LC mixture 63 within the LC cell unit 60.

Before operation of the x-ray image sensor 100 shown in FIG. 1, the object 8 to be imaged is placed between the x-ray source 2 and the x-ray image sensor 100. During operation, a positive voltage, Vbias, is applied across the conductive transparent ITO layers 43 and 67 with the latter at ground potential to produce a field strength of about 10 V per micrometer in the a-Se layer 47. The electric field created in the a-Se layer by Vbias drives the holes and electrons within the a-Se layer towards opposite surfaces of the a-Se layer with the holes being guided towards the surface adjacent the LC alignment layer 61, thereby resulting in charges collecting at the interface between the a-Se layer 47 and the pin-hole-free dielectric layer 49. Without the pin-hole-free dielectric layer, the collected holes will accumulate on the interface between the a-Se layer 47 and the LC alignment layer 61 which is not pin-hole-free but have pin-hole traps to trap x-ray generated holes resulting in image lag. The electric field ensures that there is very little lateral spread in charge movement within the a-Se layer so that the collected charges faithfully reproduce the pattern of x-rays absorbed by the a-Se layer across its entire surface.

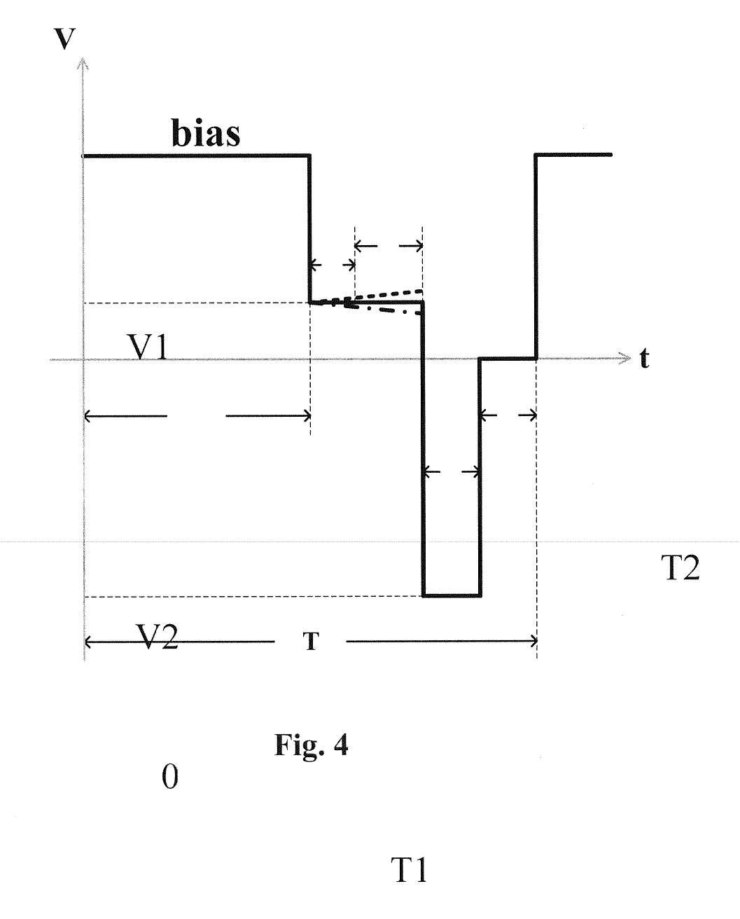

The operation to take a single x-ray image of the object can be made in a single operation cycle with a cycle time T as shown in FIG. 4 or in one of the repetitive cycles. Referring to FIG. 4, T is divided into 5 time periods from the first time period T1 to the fifth time period T5. Within the first time period T1 period, the x-ray exposure takes place, and at the same time, the applied Vbias equal to the first voltage V1 to create an electric field of preferably around 10 V per micrometer that can drive the mobile holes (or electrons as an alternative choice) created by the absorption of x-rays in the a-Se layer 47 to accumulate at the interface between the a-Se layer 47 and the dielectric layer 49 to deform the directors of the LC mixture 63 within the LC cell unit 60. However, during this the first time period T1, the V1 also causes a field to exit within the LC mixture 63 to separate ionic charges within and with negative ions (or positive ions if the polarity of V1 is reversed) drifting to accumulate at the interface between the LC alignment layer 61 and the LC mixture 63 so as to neutralize the hole charges accumulated at the interface between the a-Se layer 47 and the dielectric layer 49. These accumulated negative ions represent noise if there are not neutralized by x-ray-generated hole charges in the a-Se layer 47. However, the present invention can use actinic-light-generated hole charges within the a-Se layer 47 to neutralize these accumulated negative ions by turning on the LED light source 28 to provide actinic light incident upon the a-Se layer within the time period of T1. The present invention carries out the above action to reduce or eliminate the noise contributed from the ionic current within the PI-LC-PI.

At the end of T1, the total charge density, Qₛ, accumulated at the interface between the a-Se layer 47 and the dielectric layer 49 represents the signal from the x-ray exposure on the a-Se layer 47 with negligible noise from the dark current in the a-Se layer 47 and the effect due to ionic current in the PI-LC-PI well neutralized. In the present invention, the noise is highly suppressed. Furthermore, Qₛ is shared between two capacitances terminated at two ITO layers 43 and 67, respectively. As shown in FIG. 4, at the end of T1, the Vbias is equal to the second voltage V2 whose initial value is chosen to generate a Vbias-lc approximately equal to the threshold voltage of the PI-LC-PI, typically from 1 to 3 V. Within the second and third time periods T2 and T3, the value of V2 takes on three possible values, as a constant represented by the solid curve in FIG. 4 when the ionic current flowing within the PI-LC-PI is negligible. V2 increases with time as shown by the dash curve if the ionic current is dominant from the LC mixture 63. On the other hand, V2 decreases with time as shown by the dash-dot curve if the said ionic current is dominant from the LC alignment layers 61 and 65. T2 lasts approximately equal to the LC response time under the influence by the average of total charge density Qₛ. Following T2 is T3 during which the LED light source 27 is activated to emit non-actinic light to shine upon the x-ray image sensor 100 shown in FIG. 1 to transmit the optical image exhibited in the p-LCLV 150 towards the reflective mirror 71. The optical image is, then, focused by the lens 75 onto the receiving optical imager 77 turning on to detect the optical image at least once or many times in synchronization with the turn-on of the non-actinic light source during T3. A processor 79 is connected to the CCD camera to receive and store the image data from the optical imager 77 and outputs PACS-compatible digital image data for further storages, distributions, and displays. During the periods T2 and T3, multiple optical images can be detected by the optical imager 77 at selected time intervals after the same x-ray exposure and the multiple optical images of the x-ray exposure at the selected time intervals having the same transmission versus exposure characteristic. The processor 79 generates the digital image from selected one or the average of the optical images stored therein. The processor 79 is responsive to user input to select the optical image stored therein having a desired transmission versus exposure characteristic. During the fourth period T4 that follows T3, the actinic light of the FPBL unit 20 is turn on to flood the x-ray photoconductive unit 40 and V2 changes to the fourth voltage V4, a negative-voltage-biased ac voltage to empty the Qₛ of holes accumulated at the interface between the a-Se layer 47 and the dielectric layer 49 and to produce a reverse-bias effect for balancing DC voltage to the LC mixture 63. Following T4 is the fifth time period T5 during which the LC cell unit 60 is grounded to restore the LC mixture 63 back to the original quiescent state preparing for the next cycle of repetitive operation.

As an alternative, the present invention can change the polarity of Vbias shown in FIG. 4 to collect absorbed-x-ray-generated electrons to replace holes in Qₛ. In this case, preferably the hole-injection blocking layer 45 shown in FIG. 1 and FIG. 3 has to be replaced by an electron-injection blocking layer.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. An x-ray image sensor comprising:
a flat-panel back-light unit emitting actinic and non-actinic lights;
an x-ray-photoconductor-assisted liquid crystal light valve including a pair of polarizers placed on opposite sides of a combination of an x-ray photoconductive unit to absorb x-rays passing through an object to be imaged and create a charge image corresponding to an image of said x-rays and a liquid crystal cell unit to convert said charge image into at least one optical image illuminated by said non-actinic light emitted from said flat-panel back-light unit;
an optical imager detecting said optical image, and during said non-actinic light on period, multiple said optical images are detected by said optical imager at selected time intervals after a same x-ray exposure and said multiple said optical images of said x-ray exposure at said selected time intervals having a same transmission versus exposure characteristic; and
a processor coupled to said optical imager to convert said optical image into picture archiving and communication system (PACS)-compatible format for further storages, distributions, and displays.

2. The x-ray image sensor according to claim 1, wherein said x-ray-photoconductive unit further comprises:
a thin transparent substrate;
a first transparent conductive electrode formed on said thin transparent substrate;
a hole-injection blocking layer formed on said first transparent conductive electrode;
an x-ray photoconductive layer formed on said hole-injection blocking layer; and
a dielectric layer preferably made of transparent poly-para-xylylenes formed on said x-ray photoconductive layer.

3. The x-ray image sensor according to claim 2, wherein said x-ray photoconductive layer is an amorphous selenium layer at a thickness from 50 to 1000 nm preferably at a thickness from 100 to 300 nm.

4. The x-ray image sensor according to claim 1, wherein said flat-panel back-light unit has a negligible attenuation for incident x-rays, and said flat-panel back-light unit further comprises:
a thin reflecting back plate;
a thin light-guiding plate having light deflective elements on one of its surfaces formed adjacent said thin reflecting back plate;
two LED-light sources respectively emitting said actinic light and said non-actinic light.

5. The x-ray image sensor according to claim 2, wherein said liquid crystal cell unit further comprises a sealed liquid crystal medium in a cavity between two liquid crystal alignment layers with one said liquid crystal alignment layer fabricated on a second transparent conductive electrode coated on a transparent substrate and other said liquid crystal alignment layer fabricated on said dielectric layer.

6. The x-ray image sensor according to claim 5, wherein said two liquid crystal alignment layers are made either of oblique-evaporated oxide films or rubbed polyimide films or photo-induced-liquid crystal-alignment polyimide films.

7. The x-ray image sensor according to claim 5, wherein said liquid crystal medium has a high resistivity larger than 10¹² ohm-cm with either a positive or a negative dielectric anisotropy, preferably a twisted or reversed twisted nematic liquid crystal mixture of said high resistivity or a vertically-aligned nematic liquid crystal mixture of said high resistivity.

8. The x-ray image sensor according to claim 1, wherein said x-ray-photoconductive unit and said liquid crystal cell unit is assembled by One-Drop-Fill (ODF) process.

9. The x-ray image sensor according to claim 5, wherein a time-varying voltage waveform is applied across said first and second transparent conductive electrodes, and said time-varying voltage waveform is divided into a first time period, a second time period, a third time period, a fourth time period and a fifth time period in sequence with a first voltage, a second voltage, a fourth voltage and zero voltage applied across said first and second transparent conductive electrodes, and
during said first time period, an x-ray exposure and said actinic light from said flat-panel back-light unit are turn on, and said first voltage is applied across said first and second transparent conductive electrodes, said first voltage is a constant high voltage to produce an electric field of about 10 volts per micrometer across said x-ray photoconductive layer to collect x-ray- and light-generated electrons or holes to accumulate at an interface between said x-ray photoconductive layer and said dielectric layer;
during said second and third time periods, said second voltage takes an initial value so as to create a voltage approximately equal to a threshold voltage of said liquid crystal medium;
during said third time period, said flat-panel back-light unit, said optical imager and said processor are, at least once, turn on and off in synchronization to generate said non-actinic light, whereby said optical image is detected by said optical imager connected to said processor to output data of a digital image in said PACS-compatible format;
during said fourth time period, said actinic light of said FPBL unit is turn on to flood said x-ray photoconductive unit, and said fourth voltage is a DC-biased ac voltage to erase said charge image during said x-ray exposure within said first time period; and
during said fifth time period, said zero voltage across said first and second transparent conductive electrodes to restore said liquid crystal medium back to a quiescent state preparing for next cycle of operation.

10. The x-ray image sensor according to claim 9, wherein during said second and third time periods, said second voltage takes a constant value when an ionic current flowing within said liquid crystal medium sandwiched between said two liquid crystal alignment layers is negligible.

11. The x-ray image sensor according to claim 9, wherein during said second and third time periods, said second voltage is an increasing function of time when an ionic current flowing within said liquid crystal medium sandwiched between said two liquid crystal alignment layers is dominated by ions from said liquid crystal medium.

12. The x-ray image sensor according to claim 9, wherein during said second and third time periods, said second voltage is a decreasing function of time when an ionic current flowing within said liquid crystal medium sandwiched between said two liquid crystal alignment layers is dominated by ions from said two liquid crystal alignment layers.

13. The x-ray image sensor according to claim 9, wherein a length of said second time period is approximately equal to a response time of said liquid crystal medium.

14. The x-ray image sensor according to claim 1, wherein said optical imager is in form of at least one imaging device in a linear array or at least 4 imaging devices in a 2-by-2 array, and wherein an optical system is disposed between said x-ray-photoconductor-assisted liquid crystal light valve and said optical imager.

15. The x-ray image sensor according to claim 14, wherein said at least 4 optical imaging devices are in form of a CCD camera or a CMOS image sensor, and wherein said optical system is in form of a reflecting mirror and a lens.

16. The x-ray image sensor according to claim 1, further comprising an electronic timer providing trigger signals to said processor, and wherein when said optical imager has received sufficient light to capture said optical image, said processor digitizes and stores said optical image in response to said trigger signals.

17. An x-ray image sensor system comprising:
an x-ray source generating x-rays to pass through an object to be imaged;
an x-ray-photoconductor-assisted liquid crystal light valve including a pair of polarizers placed on opposite sides of a combination of an x-ray photoconductive unit and a liquid crystal cell unit and said x-ray photoconductive unit absorbing x-rays passing through said object, said absorbed x-rays creating variations in potential across said liquid crystal cell unit thereby to form an x-ray exposure of said object, a source of non-actinic light with sufficient intensity to pass through said x-ray-photoconductor-assisted liquid crystal light valve to create at least one optical image as a representation of said x-ray exposure;
an optical imager receiving said optical image after passing through said x-ray-photoconductor-assisted liquid crystal light valve, said optical imager at selected intervals during said non-actinic light on period to capture multiple said optical images of said x-ray exposure at different times, each of said optical images having a same transmission versus exposure characteristic; and
a processor coupled to said optical imager to digitize and store said optical images captured by said optical imager.

18. The x-ray image sensor system according to claim 17, wherein said processor generates a digital image from selected one or the average of said optical images stored therein.

19. The x-ray image sensor system according to claim 17, wherein said processor is responsive to user input to select said optical image stored therein having desired said transmission versus exposure characteristic.

20. The x-ray image sensor system according to claim 17, wherein said x-ray photoconductive unit further comprises an x-ray photoconductive layer is in the form of an amorphous selenium layer sandwiched between a hole-injection blocking layer and a dielectric layer.
